(19) United States
(12) Patent Application Publication
(10) Pub. No.: US 2012/0090129 A1
(43) Pub. Date: Apr. 19, 2012

(54) VACUUM CLEANER AND FILTER BAG

(75) Inventor: Ian Daniel LAWRENCE, Honiton (GB)

(73) Assignee: NUMATIC INTERNATIONAL LIMITED, Camberley (GB)

(21) Appl. No.: 13/241,679

(22) Filed: Sep. 23, 2011

Related U.S. Application Data
(63) Continuation of application No. PCT/GB2010/000537, filed on Mar. 24, 2010.

(30) Foreign Application Priority Data
Mar. 24, 2009 (GB) 0905097

(51) Int. Cl. A47L 9/14; B01D 46/02

(52) U.S. Cl. 15/347; 55/378

(57) ABSTRACT

A vacuum cleaner having a collection cavity into which air is drawn by a vacuum drive for the collection of air entrained detritus. The cavity has an inlet vent for entry of dirty air, a base portion for collecting detritus and an outlet, enabling the vacuum drive to-draw air into the cavity. The inlet vent comprises a stub pipe which enters the cavity. A filter bag is disposed in the base portion and includes an aperture for the entry of air-entrained detritus. The bag aperture includes a sliding fit over the stub pipe to engage with the inlet vent so the stub pipe empties into the bag. The bag includes a retaining tie which may be clamped to the aperture back along the stub pipe to prevent disengagement of the bag with the vent.

### CROSS-REFERENCE TO RELATED APPLICATION

This application is a continuation of a co-pending international application PCT/GB2010/000537, with an international filing date of Mar. 24, 2010, entitled, “VACUUM CLEANER AND FILTER BAG”, and international application GB/0905097.2, with a filing date of Mar. 24, 2009, both of which are incorporated by reference herein in its entirety.

### TECHNICAL FIELD

The present invention relates to the field of vacuum cleaning and in particular the collection of air-entrained debris, for example in a filter bag.

### BACKGROUND OF THE INVENTION

Domestic and upright and bin & wand type vacuum cleaners are typically equipped with porous paper bags into which dirt-laden air lifted from a floor or carpet is drawn by a vacuum drive. Cyclonic separators are also well known in both a domestic and industrial contexts for separation of air-entrained particles from the air stream.

Industrial and commercial bin-type cleaners are also known in which dirt is drawn from a floor surface in a tubular wand and collected a drum or bin rather than a bag. A filter layer may be used to cover a vacuum drive port typically in an upper end region of the bin. The filter prevents fine particles from leaving the bin during use and fouling the vacuum drive (typically an electric motor.) For wet collection the filter may be made from a porous plastics material or foam, so that filtering performance is not compromised by airborne liquid soaking the filter.

A particular problem exists in the field of vacuum cleaners used in construction sites to collect brick or plaster dust which is created when these materials are subject to grinding by tools. For example, when channels or tracks are formed in walls or partitions of buildings so as to permit the chasing-in of pipe work or electric cabling or the like into the wall. Large volumes of very fine dust are generated by such processes. So as to avoid contaminating the building interior with dust, vacuum cleaner attachments are provided for the grinding tools so that the dust may be collected. In addition health and safety requirements mean that dust contamination should be minimized. Thus air recirculation filters may be used in combination with the vacuum cleaners.

Known cleaners which are used in a contract cleaning or commercial environment tend to collect detritus in a bin portion of the cleaner, rather than in a filter bag. The machines may be conveniently emptied by detaching a lid portion of the bin and tipping the contents into a refuse sack. Machines of this type are available from the present applicant and are marketed under the trade name Henry, amongst others.

Occasionally it is desired to convert these cleaners for use with a filter bag, for instance where harmful or dangerous fine dust is to be collected and wherein a conventional emptying and transfer into a refuse sack would release dust into the atmosphere. GB application GB0822365.3 discloses a perforated cylindrical rigid insert for a vacuum cleaner, which insert houses a filter bag and is provided with circumferential spacers which maintain an annular air gap around the bag. This allows the bag to expand under vacuum loading, without becoming occluded against a wall of the machine against which the bag would otherwise impinge. Thus an annular airflow path around the bag is maintained.

In converting a non-bag type cleaner to operate with a bag it is necessary provide an aperture in the filter bag whereby air drawn from a cleaned surface can pass into the bag and deposit detritus therein before being drawn through the bag walls towards the vacuum source. In known arrangements the bag is provided with an aperture through a side wall and the aperture is defined by an annular collar formed of a rigid plastics material. The collar may be engaged with a duct member or vent fed by a vacuum work head such as a brush tool or wand.

In one arrangement the collar is a sliding fit on a horizontal stub pipe which protrudes into the collection cavity. A problem arises when it is desired to fit or remove the bag. Because the bag collar is only a sliding fit, it may detach from the stub pipe and allow spilling of the bag contents (if the bag is full) or a loss of communication between the pipe and bag if the case of a newly fitted bag.

GB-A-677,060 discloses a vacuum cleaner in which a spring connector is provided for retaining a vacuum cleaner dust bag on a mounting collar. EP-A-0,880,932 discloses a vacuum cleaner which has a dust collection chamber in which is located a first collection bag. A second, water resistant, open collection bag accommodates the first bag. The second bag has an upper rim portion which is clamped between a chamber upper rim and a lid portion. U.S. Pat. No. 2,742,105 discloses a vacuum cleaner filter bag which has a stiff cardboard top plate formed with a hole which communicates with the bag interior. A rim of the plate may be clamped into position in a vacuum cleaner so as to retain the bag in position.

The present invention seeks to address the problem of retaining a bag in position in a vacuum cleaner.

### SUMMARY OF THE INVENTION

The invention concerns vacuum cleaners of a type having a collection cavity into which air is drawn by a vacuum drive for the collection of air entrained detritus, the cavity being provided with an inlet vent for entry of dirty air, and a base portion in which detritus is collected in use and an outlet formed in an upper region of the cavity and which is in gas communication with the vacuum drive for drawing air into the cavity. A filter bag is disposed in the base portion, the filter bag having an aperture for the entry of air-entrained detritus, wherein the inlet vent comprises a stub pipe which enters into the cavity and wherein the bag aperture is a sliding fit over the stub pipe so that the bag may be engaged with the vent by sliding the aperture at least part of the way along the stub pipe so that a free end of the stub pipe empties into the interior of the bag, characterised in that the bag is provided with a retaining tie which may be clamped to restrict travel of the aperture back along the stub pipe to cause disengagement of the bag with the vent.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a front view of a vacuum cleaner according to the present invention.

FIG. 2 is a perspective view of a filter bag according to the invention.

FIG. 3 is sectional view from one side of a vacuum cleaner in accordance with the present invention.

### DETAILED DESCRIPTION OF THE PREFERRED EMBODIMENT

It is an object of the present invention to provide an improved means for retaining a bag in position in a vacuum cleaner.

According to the present invention there is provided a vacuum cleaner of a type having a collection cavity into which air is drawn by a vacuum drive for the collection of air entrained detritus, the cavity being provided with an inlet vent for entry of dirty air, and a base portion in which detritus is collected in use and an outlet formed in an upper region of the cavity and which is in gas communication with the vacuum drive for drawing air into the cavity, wherein a filter bag is disposed in the base portion, the filter bag having an aperture for the entry of air-entrained detritus, wherein the inlet vent comprises a stub pipe which enters into the cavity and wherein the bag aperture is a sliding fit over the stub pipe so that the bag may be engaged with the vent by sliding the aperture at least part of the way along the stub pipe so that a free end of the stub pipe empties into the interior of the bag, characterised in that the bag is provided with a retaining tie which can be clamped to retain the aperture on the stub pipe. In other words, the tie restricts travel of the aperture back along the stub pipe to cause disengagement of the bag with the vent.

The stub pipe is preferably generally horizontally oriented. The retaining tie may be fixed at one end to a collar which defines the bag aperture. The retaining tie may comprise a flexible web of material, such as a flexible plastics material or a rubberised textile.

The vacuum cleaner is preferably provided with a retaining clamp, which may act on a free end region of the retaining tie.

The collection cavity may be defined by a lower housing portion and an upper housing (or lid) portion, which portions are releasably clamped together to form the cavity and wherein the tie-retaining clamp comprises a portion of the interface between the said upper and lower housing portions in which the tie free end may be trapped.

The stub pipe typically projects into the cavity from an upper side wall region of the cavity.

The vacuum wand may be a bin/drum and wand type cleaner (also known as a canister type cleaner) and wherein the vent is fed by the wand portion and the collection cavity is formed in the bin/drum.

According to another aspect of the invention, there is provided a filter bag for a vacuum cleaner comprising a filter web which defines an internal volume and with an aperture formed therethrough for allowing an airflow into the internal volume under vacuum suction, wherein a tie is fixed at one end to a portion of the web adjacent the aperture with a free end available to be clamped.

The tie may comprise a tongue of flexible material, such as plastics film or a textile or any other material which may be clamped.

The aperture may be defined by a rigid collar piece. The collar piece may in itself be disposed on (or integral with) a mounting plate, which may surround the collar. The said one end of the tie may be fixed to, or adjacent to, the collar. The tie may be fixed to the mounting plate.

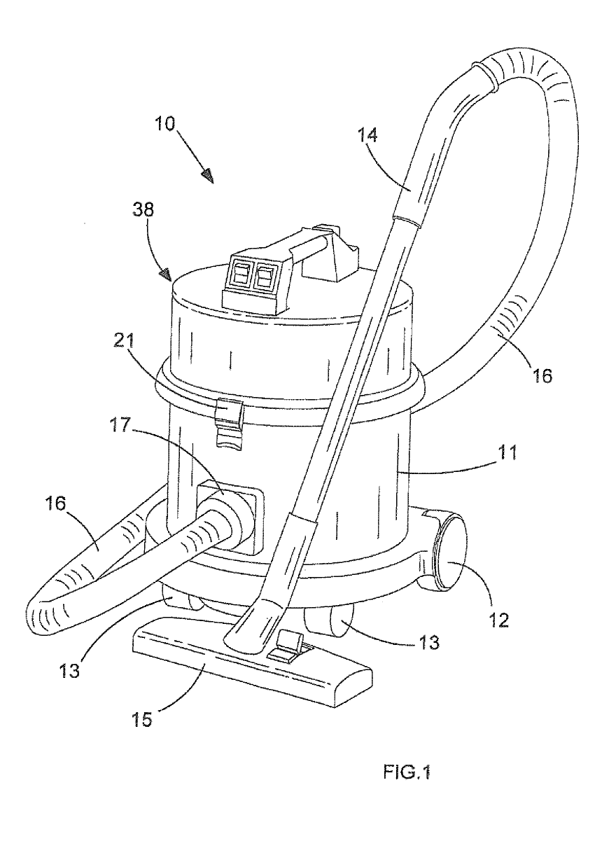

In FIG. 1 a vacuum cleaner according to the invention is shown generally as 10. The vacuum comprises a generally cylindrical base portion 11. The base portion has a lower end region which is provided with two spaced apart rear wheels 12 (only one visible) and two spaced apart front castors 13.

A sidewall of the base portion is formed with an inlet port 17. An outer region of the port 17 is engaged with a tubular flexible air-conveyance pipe 16. The pipe 16 leads to a rigid wand 14. A distal end of the wand is provided with a work head 15 which has an underside (not visible) provided with a brush and a slot for drawing in detritus lifted by the brush.

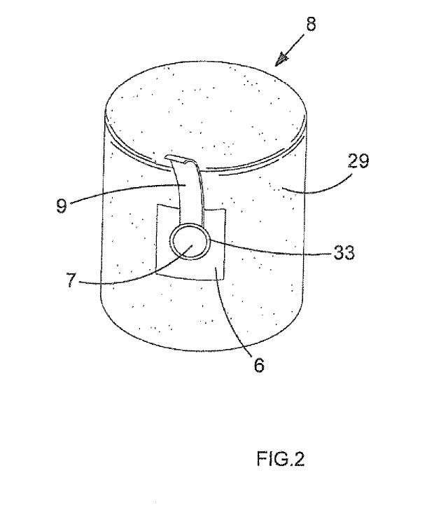

In FIG. 2 a filter bag for an industrial vacuum cleaner is shown generally as 8. The bag 8 is formed as a drum or cylindrical web of permeable polymer felt material, having sidewalls 29. An upper side region of the cylindrical side wall is formed with an aperture 7. The aperture 7 is defined by an annular collar piece 33 formed of moulded plastics material. The collar 33 is moulded integrally with a generally rectangular mounting plate 6 which is fused to the membrane material. An elongate rectilinear tongue 9 of flexible plastics material is fused to an upper region of the collar 33 and the underlying mounting plate.

The bag 8 is disposed in the interior cavity 30 of the vacuum cleaner as shown in

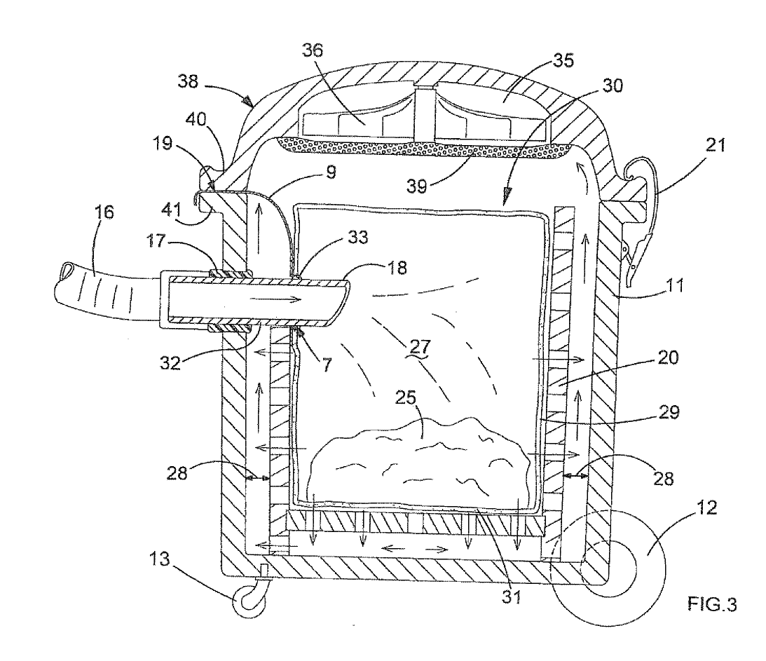

FIG. 3. The vacuum cleaner has a lower generally cylindrical base portion 11 which defines the internal cylindrical collection cavity 30. A filter bag holder 20 is located in the cavity. The holder is a generally cylindrical article having perforated base and sidewalls, with an open upper end. External axial spacers (not shown) keep the holder spaced apart from the cavity walls so as to maintain an air gap 28. The bag 8 is accommodated in the bag holder, as shown in the Figure.

An upper side wall of the base portion is formed with a port 17. The port 17 communicates between the base portion interior 30 and a tubular wand portion 16 of the machine. The port 17 comprises a stub tube 32 which projects radially inwardly from the side wall and passes through the holder wall and via the collar 33 into the bag interior 27.

The stub tube 32 has an open bevelled distal end 18 for discharging detritus-entrained air into the bag interior 27. Upon entry into the bag 8 the volume expansion causes the airflow speed to slow and the detritus 25 to fall to the base of the bag 8.

The domed lid portion 38 of the machine is provided with an electric motor and suction fan assembly 36 thereby drawing air up into the lid portion via a disc shaped porous foam filter 39.

The elongate rectilinear tongue 9 has a base end which is fixed to an upper portion of the collar 33. A distal end region 19 of the tongue is sandwiched between mating circumferential edges 40,41 of the lid portion and base portion respectively. The lid and base portions are clamped by axially compressible claw clamps 21 (one only shown in FIG. 3, but a second is shown in FIG. 1). Thus the tongue is clamped between the lid and base portions.

The stub tube 32 projects into the collar 33 in a sliding fit, with the clamped tongue retaining the collar 33 on the tube 32. When it is desired to remove the bag 8 for disposal and replacement, the lid and base portion are unclamped, thereby releasing the tongue. The collar 33 may then be slid off the stub tube 32 and the bag 8 lifted out of the bag holder and base portion. A new bag 8 may then be placed in the base portion and its collar 33 slid onto the stub tube 32. The tongue is then laid over an upper edge 41 of the base portion and the lid mated on top of the base, trapping the tongue between the upper and lower mating edges 40,41.

In this way the bag 8 is prevented from detaching from the stub tube 32, thereby ensuring that in use detritus enters the bag 8 rather than spilling out on top of the bag 8. This is particularly important when dense dust is collected, which can tend to pull the bag 8 down an off the stub tube 32 as the bag 8 sags as it fills.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A vacuum cleaner of a type comprising a collection cavity into which air is drawn by a vacuum drive for the collection of air entrained detritus, the cavity being provided with an inlet vent for entry of dirty air, and a base portion in which detritus is collected in use and an outlet formed in an upper region of the cavity and which is in gas communication with the vacuum drive for drawing air into the cavity, wherein a filter bag is disposed in the base portion, the filter bag having an aperture for the entry of air-entrained detritus, wherein the inlet vent comprises a stub pipe which enters into the cavity and wherein the bag aperture is a sliding fit over the stub pipe so that the bag may be engaged with the vent by sliding the aperture at least part of the way along the stub pipe so that a free end of the stub pipe empties into the interior of the bag, wherein the bag is provided with a retaining tie which may be clamped to restrict travel of the aperture back along the stub pipe to cause disengagement of the bag with the vent.

2. A vacuum cleaner as claimed in claim 1, wherein the stub pipe has a generally horizontally orientation in the cavity.

3. A vacuum cleaner as claimed in claim 1, wherein the retaining tie is fixed at one end to a collar which defines the bag aperture.

4. A vacuum cleaner as clamed in claim 1, wherein the retaining tie is fixed at one end to a region of the bag adjacent to a collar which defines the bag aperture.

5. A vacuum cleaner as clamed in claim 1, wherein the retaining tie comprises a flexible web of material.

6. A vacuum cleaner as clamed in claim 1, which is provided with a retaining clamp which can act on the free end of the retaining tie.

7. A vacuum cleaner as claimed in claim 6, wherein the collection cavity is defined by a lower housing portion and an upper housing portion, which portions are releasably clamped together to form the cavity and wherein the tie-retaining clamp comprises a portion of the interface between the said upper and lower housing portions in which the tie free end may be trapped.

8. A vacuum cleaner as clamed in claim 1, wherein the stub pipe projects into the cavity from an upper side wall region of the cavity.

9. A vacuum cleaner as clamed in claim 1, which is a drum and wand type cleaner and wherein the vent is fed by the wand portion and the collection cavity is formed in the drum.

10. A filter bag for a vacuum cleaner comprising a filter web which defines an internal volume and with an aperture formed therethrough for allowing an airflow into the internal volume under vacuum suction, wherein a tie is fixed at one end region to a portion of the bag and with a free end region of the tie available to be clamped.

11. A filter bag as claimed in claim 10, wherein the tie is fixed at said one end region to a portion of the bag adjacent the bag aperture.

12. A filter bag as claimed in claim 10, wherein the tie comprises a tongue of flexible material.

13. A filter bag as claimed in any of claims 10, wherein the aperture is defined by a collar piece.

14. A filter bag as claimed in claim 13, wherein said one end region of the tie is fixed to the collar, or to a bag portion adjacent the collar.

15. A filter bag as claimed in claim 14, wherein the collar is disposed in or on a plate.

16. A filter bag as claimed in claim 10 wherein the aperture is defined by a collar and said one end region of the tie is fixed to a bag portion adjacent the collar.

17. A filter bag as claimed in claim 16 wherein the collar is disposed in or on a plate and the said end region of the tie is attached to the plate.
